(19) United States
(12) Patent Application Publication
(10) Pub. No.: US 2007/0006262 A1
(43) Pub. Date: Jan. 4, 2007

(54) Automatic content presentation

(75) Inventors: Michael A. Cleron, Menlo Park, CA (US); Peter T. Barrett, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/172,395

(22) Filed: Jun. 30, 2005

(51) Int. Cl. H04N 7/173; G06F 3/00; G06F 13/00; H04N 5/445; H04N 7/16

(52) U.S. Cl. 725/42; 725/38; 725/8; 725/41; 725/88; 725/102

(57) ABSTRACT

Automatic content presentation is described. In an embodiment, a subscription content on-demand system includes subscription on-demand channels that each provide on-demand content which can be selected for viewing. The system also includes a promotional preview to display preview segments of the on-demand content that is available via a subscription on-demand channel, where the promotional preview is configured to enable content navigation of the promotional preview. A user interface displays promotional media that corresponds to the on-demand content, where a display of a promotional media that corresponds to on-demand content substantially coincides with a display of a preview segment in the promotional preview that corresponds to the on-demand content.

### BACKGROUND

Television viewing is increasingly “on-demand” and the use of digital video recorders (DVRs) and other video on-demand playback systems are shifting viewing habits from having to watch broadcast programs at programming times scheduled by a provider of the programs to being able to watch pre-recorded broadcast and/or on-demand programs at a time convenient for a viewer. Subscription video on-demand enables a popular movie channel, for example, to provide a line-up of movies, on-demand videos, and other recorded programming which a viewer can select to watch when it is convenient for the viewer. Unlike a conventional pay-per-view channel from which a viewer can only select a movie that is currently being shown or about to start, a viewer can select from a line-up of various options via a subscription video on-demand channel. When a viewer tunes to a subscription video on-demand channel, a loop of preview movie trailers can be displayed and, when the viewer decides which movie to watch, the viewer can then call up a menu display from which the movie can be selected for viewing.

### SUMMARY

This summary is provided to introduce simplified concepts of automatic content presentation which is further described below in the Detailed Description. This summary is not intended to identify essential features of the claimed subject matter, nor is it intended for use in determining the scope of the claimed subject matter.

In an embodiment of automatic content presentation, a subscription content on-demand system includes subscription on-demand channels that each provide or make available on-demand content, such as videos on-demand, which can be selected for viewing. The system also includes a promotional preview to display preview segments of the on-demand content that is available via a subscription on-demand channel. The promotional preview can be displayed when a viewer selects a subscription on-demand channel. In an implementation, the promotional preview can be a produced video that includes content navigation markers, or have an associated data file of content navigation references, to enable content navigation of the promotional preview.

The promotional preview can be generated by concatenating, or sequencing, references to video trailers and/or additional media content that corresponds to the on-demand content for a particular subscription on-demand channel. A user interface implemented as a browser bar displays promotional media, such as an image of a poster that corresponds to the on-demand content. A display of the promotional media that corresponds to the on-demand content substantially coincides with a display of a preview segment in the promotional preview that corresponds to the on-demand content. The promotional media, such as a poster image, can be selected via the browser bar to initiate playback of on-demand content which is represented in the promotional preview by the corresponding video trailer.

### BRIEF DESCRIPTION OF THE DRAWINGS

The same numbers are used throughout the drawings to reference like features and components.

FIG. 1 illustrates an exemplary subscription content on-demand system in which embodiments of automatic content presentation can be implemented.

FIG. 2 illustrates an exemplary promotional preview in an embodiment of automatic content presentation.

FIG. 3 illustrates another exemplary promotional preview in an embodiment of automatic content presentation.

FIG. 4 illustrates an exemplary promotional preview display that coincides with a user interface which displays promotional media and other associated media content.

FIG. 5 illustrates an exemplary method for automatic content presentation.

FIG. 6 illustrates another exemplary method for automatic content presentation.

FIG. 7 illustrates various components of an exemplary digital video recorder (DVR)-enabled client device in which embodiments of automatic content presentation can be implemented.

FIG. 8 illustrates various devices and components in an exemplary entertainment and information system in which embodiments of automatic content presentation can be implemented.

### DETAILED DESCRIPTION

Automatic content presentation is described in which embodiments provide techniques to dynamically create promotional previews for subscription on-demand channels, such as for subscription video on-demand channels. A content provider can select or designate the on-demand content that will be available through each of the subscription on-demand channels. The content provider may choose to promote new releases, top movie picks, or any other set of on-demand content that will be available for viewing for a duration of time, such as over a one-month period. The on-demand content can include any form of movies, programs, music, movie trailers, preview segments, and similar audio, video, image content, and/or combination thereof.

When a viewer selects a subscription on-demand channel, such as from an electronic program guide, a promotional preview displays preview segments of the on-demand content that is available via the selected subscription on-demand channel. For example, if the viewer selects a subscription video on-demand channel, a promotional preview can be displayed that includes movie trailers which correspond to the on-demand movies that are available for viewing via the selected subscription video on-demand channel.

The promotional preview can be automatically created as preview segments are sequenced from an on-demand content data store and concatenated to generate the promotional preview. Other promotional media and/or associated media content can also be sequenced into the promotional preview as interstitials between the preview segments. For a promotional preview that is provided as a produced video, for example, the promotional preview can also include content navigation markers to enable user content navigation of the promotional preview with content navigation commands (also referred to as DVR-based “trick modes”).

A user interface can be implemented as a browser bar to display promotional media, such as an image of a poster that corresponds to the on-demand content. The browser bar can be implemented as an interactive interface element with various selectable controls (e.g., user-selectable buttons) and/or other elements that facilitate media navigation. A display of a poster image in the browser bar substantially coincides with a display of a preview segment in the promotional preview, and both correspond to the available on-demand content. The promotional media, such as the poster image, can be selected via the browser bar to initiate playback of the on-demand movie which is represented in the promotional preview by the corresponding video trailer.

While aspects of the described systems and methods for automatic content presentation can be implemented in any number of different computing systems, environments, television-based entertainment systems, and/or configurations, embodiments of automatic content presentation are described in the context of the following exemplary system architectures.

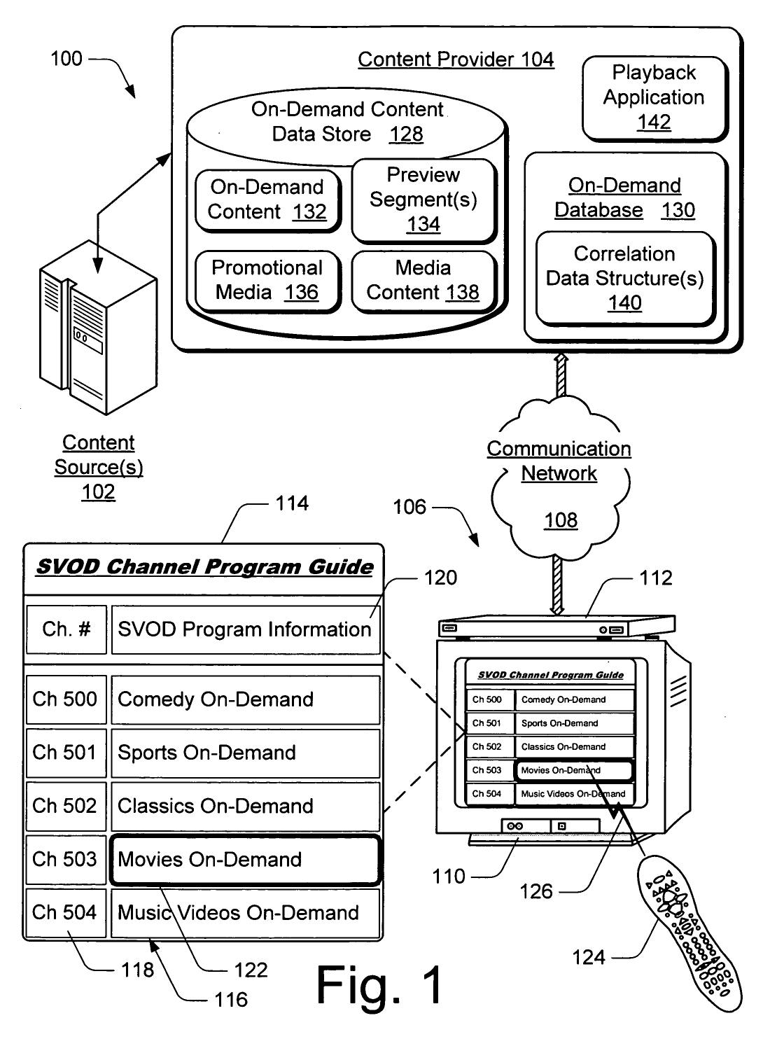

FIG. 1 illustrates an exemplary subscription content on-demand system 100 in which embodiments of automatic content presentation can be implemented. In this example, system 100 includes content source(s) 102, a content provider 104, and a television-based client system 106 that is configured for communication with content provider 104 via a communication network 108, which in this example, is an IP-based network. The client system 106 receives program content, various forms of media content, program guide data, advertising content, and the like from content server(s) of the content provider 104 via the IP-based network 108.

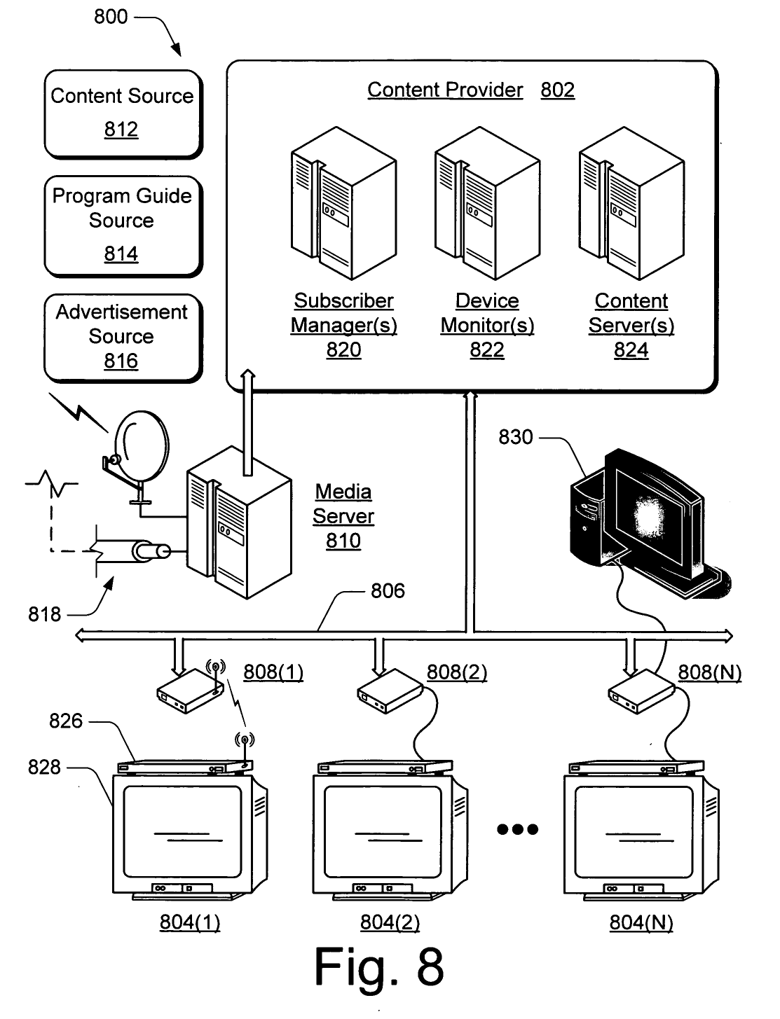

The television-based client system 106 includes a display device 110 (e.g., a television, LCD display, and the like) and a client device 112. The client device 112 can be implemented in any number of embodiments, such as a set-top box, a digital video recorder (DVR) and playback system, a personal video recorder (PVR), an appliance device, a gaming system, any combination thereof, and as any other type of client device that may be implemented in a television-based entertainment and information system. In an embodiment, the client device 112 can be implemented with any one or combination of the components described with reference to the DVR-enabled client device 700 shown in FIG. 7. Further, any combination of the components described with reference to the subscription content on-demand system 100 can be implemented in the exemplary television-based system 800 that includes examples of both a network-based content provider and television-based client devices as described with reference to FIG. 8.

Client device 112 can include an electronic program guide application to display subscription on-demand channels that each provide, or make available, on-demand content which a user can select for viewing. In an IP-based system, a program guide can include any type of selectable media, such as broadcast television, recorded programs, videos on-demand, pay-per-view selections, photo albums, music and other audio, and/or any combination thereof. In this example, a subscription video on-demand (SVOD) channel program guide 114 is displayed on display device 110. A subscription on-demand content channel can be implemented such that a viewer can access on-demand content selected to be available through the content provider 104.

A particular subscription video on-demand channel associated with a popular movie channel may offer a menu, or line-up, of movies, sporting events, original programming, special events, and the like which a viewer can select to watch when it is convenient for the viewer. Unlike a conventional pay-per-view channel from which a viewer can only select a movie that is currently being shown or about to start, a viewer can select from a line-up of various options via a subscription content on-demand channel. Further, a viewer that selects a video on-demand via a conventional pay-per-view channel will be charged for each individual movie order, whereas a subscription video on-demand service can be subscribed to on a monthly basis, for example, and the viewer has access to a selected library of content that is made available via a subscription video on-demand channel.

The SVOD channel program guide 114 enables a viewer (e.g., a subscriber associated with client device 112) to navigate a grid 116 to select a subscription video on-demand channel. The program guide 114 includes a subscription on-demand channel identifier 118 (which in this example is a channel number), and information 120 that describes or is associated with a channel identifier 118 to indicate the type of on-demand content available via a corresponding subscription on-demand channel 118. Although not shown, any type of additional information corresponding to a subscription on-demand channel 118 may be included in the SVOD channel program guide 114 to inform a viewer about the on-demand content that is available via a particular subscription on-demand channel 118.

The SVOD channel program guide 114 includes a selectable control 122 shown implemented as an on-screen focus that can be positioned to designate subscription on-demand content (and/or an on-demand channel 118) and, when selected, previews of the on-demand content available via the selected subscription on-demand channel can be rendered for viewing on display device 110. A viewer can move selectable control 122 within program guide 114, and can select an on-demand channel 118 by manipulating an input device, such as remote control 124 via which the viewer can input control commands 126.

The content provider 104 can be implemented as a network television operator or cable system operator, for example, that controls the distribution of media content, such as television programs, on-demand movies, music, and the like to various subscriber client devices, such as client device 112. In this example, the content provider 104 includes an on-demand content data store 128 and an on-demand database 130. Content provider 104 receives on-demand content 132, such as movies, music, and any other form of recorded media content from the content source(s) 102 and maintains the on-demand content 132 in the on-demand content data store 128. The content provider 104 also receives preview segments 134, such as movie trailers, promotional media 136, such as images of movie posters, and/or any other associated media content 138 from the content source(s) 102. The preview segments 134, promotional media 136, and the other associated media content 138 are also maintained in the on-demand content data store 128.

The on-demand content 132 and the preview segments 134 can include any form of movies, programs, music, movie trailers, and similar audio, video, image content, and/or combination thereof that may be broadcast, communicated, or otherwise received from a content source 102. Further, the promotional media 136 and the media content 138 can include any form of audio, video, graphics, text, image content, and/or combination thereof that may be broadcast, communicated, or otherwise received from a content source 102. The on-demand content data store 128 can be implemented as any combination of different memory component(s) to maintain, or otherwise store, any forms of the content that may be received from a content source 102.

The on-demand database 130 maintains correlation data structure(s) 140 that are utilized to correlate a subscription on-demand channel 118 with the on-demand content 132 that is available for viewing via the subscription on-demand channel. Additionally, a correlation data structure 140 can be utilized to correlate the on-demand content 132 with the one or more associated preview segments 134, associated promotional media 136, and/or related media content 138. A correlation data structure can be implemented with any type of data structure and reference system to correlate the various media types corresponding to a particular subscription content on-demand channel 118.

The content provider 104 can also include a DVR-based playback application 142 that can implement embodiments of automatic content presentation. The playback application 142 can be implemented to receive and process media content requests from client device 112 via the communication network 108 where the media content requests correspond to viewer selectable inputs at client device 112 (e.g., inputs received as media content navigation inputs 126, such as from the user-operated remote control device 124). A media content navigation input 126 can include a command to advance the media content (to include play, fast-forward, or skip-ahead commands), commands to pause or stop the media content, a command to reverse the media content (to include rewind and skip-back commands), and any other similar media content navigation command. Although illustrated and described as a single application, the playback application 142 can be implemented as several distributed component applications to implement embodiments of automatic content presentation.

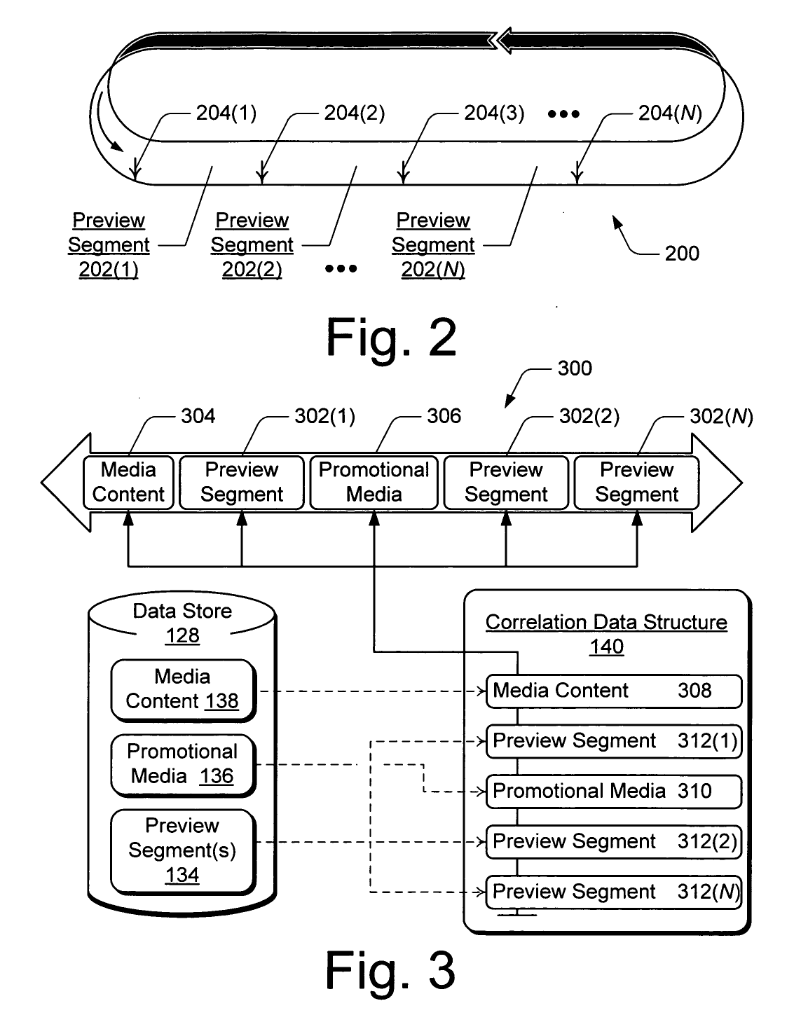

FIG. 2 illustrates an exemplary promotional preview 200 in an embodiment of automatic content presentation, and is described with reference to the subscription content on-demand system 100 shown in FIG. 1. When a viewer selects a subscription video on-demand channel 118 from the SVOD channel program guide 114, a promotional preview is rendered for the viewer to display the on-demand content that is available via the selected subscription video on-demand channel. In this example, the promotional preview 200 is generated by a content source 102 as a produced video and communicated to the content provider 104 for distribution to various client systems, such as to client device 112 of client system 106.

The promotional preview 200 includes preview segments 202(1-N), such as movie trailers, of the on-demand content 132 that is available via a subscription on-demand channel 118. The promotional preview 200 may also include content navigation markers 204(1-N) to enable interaction and content navigation of the promotional preview. Alternatively, the promotional preview 200 may have an associated data file that includes content navigation references to facilitate content navigation of the promotional preview. In this example, the promotional preview 200 is a continuing preview loop of movie trailers (e.g., preview segments 202) with the content navigation markers 204 to navigate the promotional preview forward and backward (e.g., with play, fast-forward, skip-ahead, skip-back, and rewind commands). These media content navigation commands are also referred to as “trick modes” which a viewer can input 126 with a user-operated remote control device 124 at client device 112. For example, a viewer may be watching preview segment 202(1) and want to skip-ahead to preview segment 202(2). The viewer can enter the content navigation command with remote control device 124 and the promotional preview jumps to the next item in the preview (e.g., to the beginning of preview segment 202(2)).

FIG. 3 illustrates an exemplary promotional preview 300 in an embodiment of automatic content presentation, and is described with reference to the subscription content on-demand system 100 shown in FIG. 1. When a viewer selects a subscription video on-demand channel 118 from the SVOD channel program guide 114, the promotional preview 300 can be distributed to client device 112 via communication network 108 to display the on-demand content that is available via the selected subscription video on-demand channel. In this example, the promotional preview 300 is generated by concatenating, or sequencing, references to any combination of various preview segments 302(1-N), media content 304, and/or promotional media 306.

The on-demand content that is available via a subscription on-demand channel is a subset of the on-demand content 132 maintained in the on-demand content data store 128. The content provider 104 can select or designate the subset of on-demand content that will be available through each of the subscription content on-demand channels. The content provider may choose to promote new releases, top movie picks, or any set of the on-demand content 132 that will be available for viewing for a duration of time, such as over a one-month period.

A correlation data structure 140 then correlates the preview segments 134, promotional media 136, and/or media content 138 that corresponds to the selected on-demand content that is available via a particular subscription content on-demand channel. For example, when a viewer selects or tunes to a subscription video on-demand channel 118, a playback application can query the on-demand database 130 to determine a list of media content for the selected on-demand channel 118 from the correlation data structure 140. The playback application can be the playback application 142 implemented at content provider 104, or may be a playback application implemented at client device 112.

The correlation data structure 140 includes references to the data store 128 to correlate the various content components of the promotional preview 300. For example, the correlation data structure 140 includes a media content reference 308 that correlates media content 138 as the sequenced segment of media content 304 in the promotional preview 300. Similarly, the correlation data structure 140 includes a promotional media reference 310 that correlates promotional media 136 as the sequenced segment of promotional media 306 in the promotional preview 300. Similarly, the correlation data structure 140 includes preview segment references 312(1-N) that each correlate a preview segment 134 as the respective sequenced preview segments 302(1-N) in the promotional preview 300.

The promotional preview 300 is automatically created as the preview segments 302(1-N), media content 304, and promotional media 306, is sequenced from the data store 128 according to the correlation data structure 140. In an embodiment, the references 308, 310, and 312(1-N) in the correlation data structure 140 can be implemented as universal resource locators (URLs) utilizing the HTTP protocol to reference the various media files (e.g., content sources) in the data store 128. Similarly, other protocols and/or references to the media files can be implemented for embodiments of automatic content presentation.

The promotional preview 300 can also be implemented to enable interaction and content navigation of the promotional preview. In this example, the promotional preview 300 is a continuing preview loop of the sequenced preview segments 302(1-N), media content 304, and/or promotional media 306. A viewer can navigate the promotional preview 300 forward and backward (e.g., with play, fast-forward, skip-ahead, skip-back, and rewind commands).

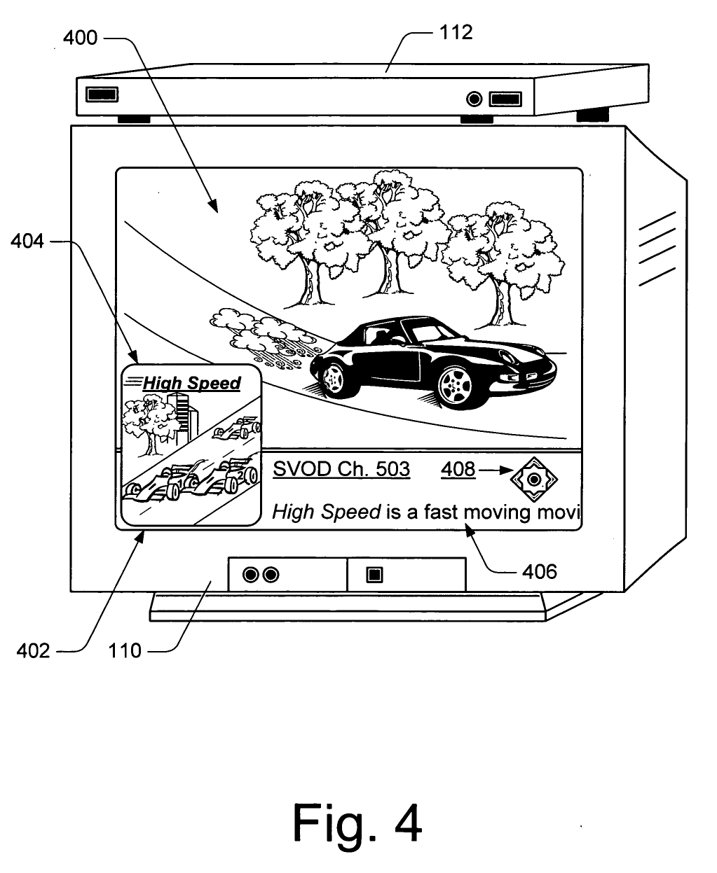

FIG. 4 illustrates an exemplary promotional preview display 400 that coincides with a user interface 402 which displays promotional media 404 and other associated media content 406, and is described with reference to the subscription content on-demand system 100 shown in FIG. 1. The promotional preview 400 can be implemented as a type of promotional preview 200 shown in FIG. 2 or as a type of promotional preview 300 shown in FIG. 3, and is displayed on display device 110 via client device 112. In an embodiment, the user interface 402 is a browser bar to display poster image(s) (e.g., promotional media 404) and other metadata (e.g., media content 406).

In this example, the display of promotional media 404 corresponds to particular on-demand content that is available via a subscription content on-demand channel. Further, the display of the promotional media 404 substantially coincides with the display of the current preview segment in the promotional preview 400 which also corresponds to the on-demand content. As the promotional preview 400 continues to display the next sequenced preview segment, the promotional media 404 and the associated media content 406 will change to promotional media and/or other media content that corresponds to the next sequenced preview segment.

Both the promotional preview 400 and the contents of the browser bar (e.g., user interface 402) are navigable together and, as the display of the promotional preview changes, so does the content of the browser bar. A viewer can select or initiate content navigable inputs 408 to advance or reverse the promotional preview 400 to a preview segment (e.g., video trailer) that corresponds to a selected one of the promotional media 404 (e.g., poster images). Further, the poster image 404 that corresponds to a particular video on-demand is selectable via the browser bar to initiate playback of the particular video on-demand which is represented in the promotional preview 400 by the corresponding video trailer.

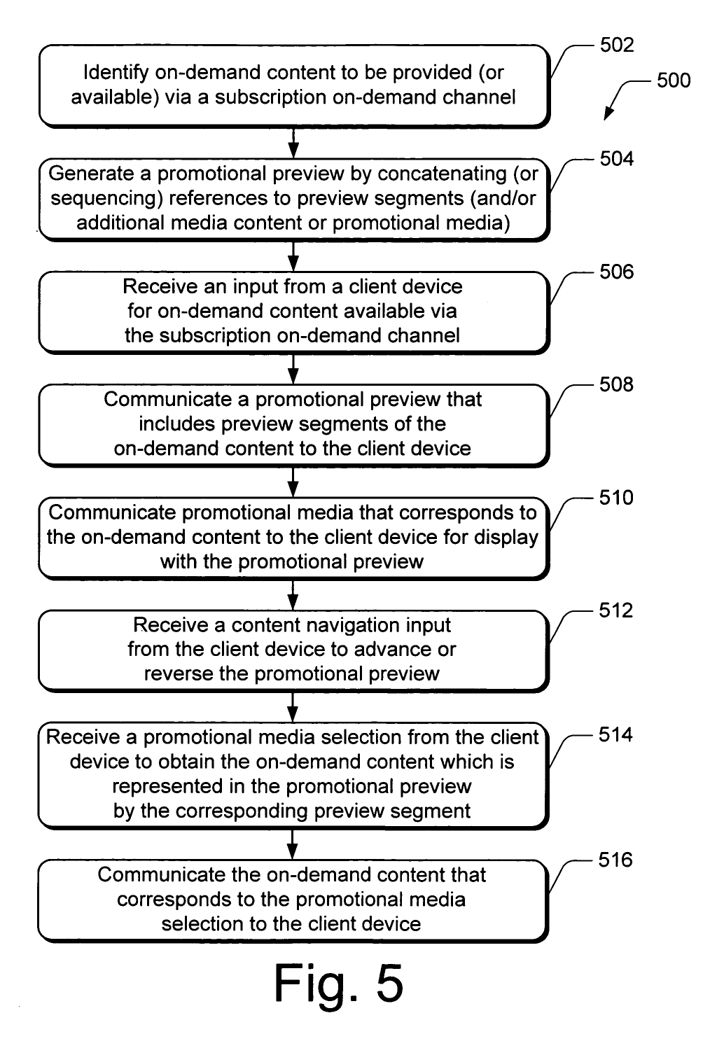

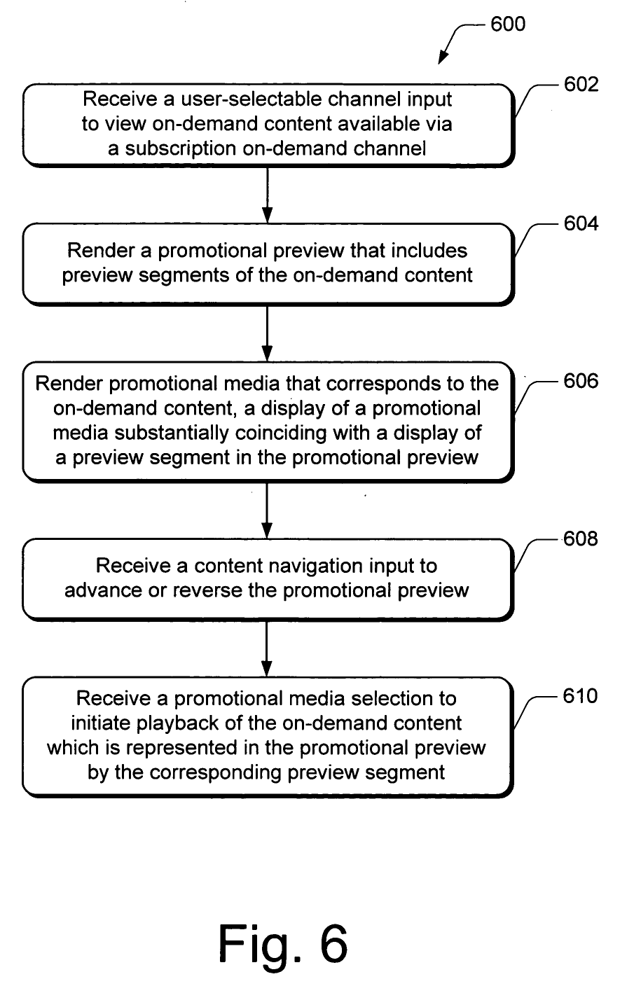

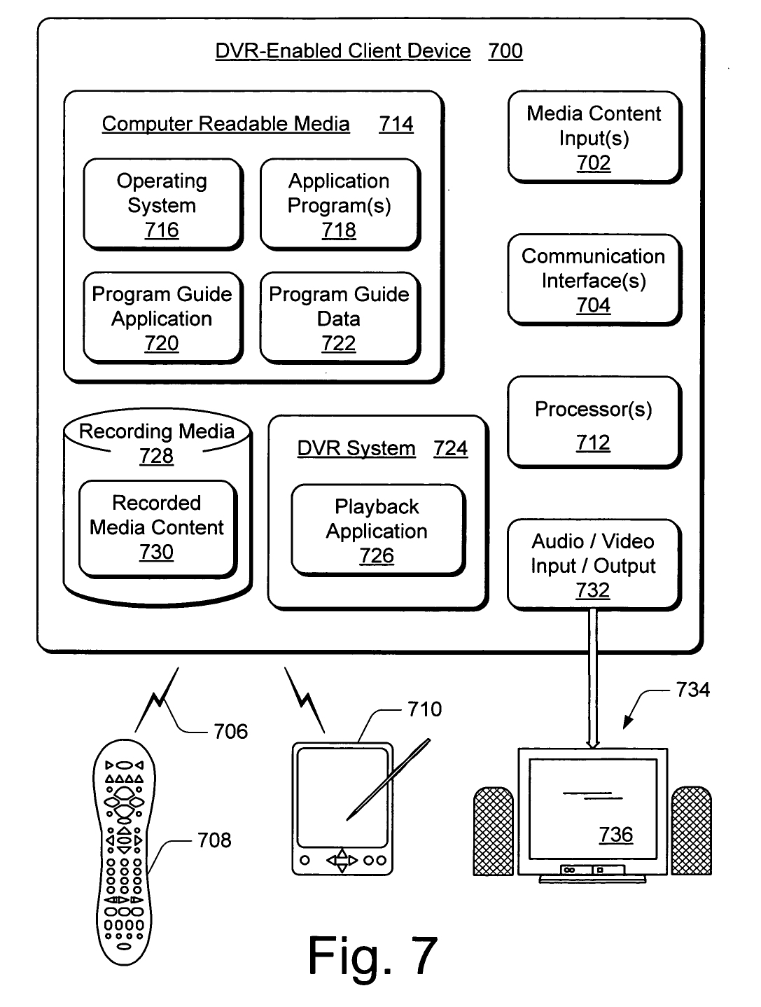

Methods for automatic content presentation, such as exemplary methods 500 and 600 described with reference to respective FIGS. 5 and 6 may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for automatic content presentation, and is described with reference to content provider 104 in the subscription content on-demand system 100 shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 502, on-demand content is identified which is to be provided, or available, via a subscription on-demand channel. For example, content provider 104 designates, or selects, the on-demand content to be made available via the subscription video on-demand channels 118, where the on-demand content that is made available is a subset of selectable on-demand content 132 maintained in the on-demand content data store 128. In an embodiment, only a subset of all of the content that may be available via a subscription video on-demand channel is featured in a preview for the channel.

At block 504, a promotional preview is generated by concatenating, or sequencing, references to preview segments (and/or additional media content or promotional media). For example, promotional preview 300 is generated at content provider 104 with the correlation data structure 140 which includes media content references 308, 310, and 312(1-N) to sequence the various media content 138, promotional media 136, and/or preview segments 134 in the promotional preview 300, respectively. The media content 138 which correlates to the sequenced segment of media content 304 can be any type of additional media that is associated with the corresponding subscription on-demand channel or the on-demand content that is available via the subscription on-demand channel.

At block 506, an input is received from a client device for on-demand content available via the subscription on-demand channel. For example, content server 104 receives an input to preview on-demand content 132 from client device 112 via the communication network 108. The input from client device 112 can be generated from, or in response to, a user-selectable input 126 from a viewer that operates remote control device 124 to select a subscription video on-demand channel 118 for viewing.

At block 508, a promotional preview that includes preview segments of the on-demand content is communicated to the client device. For example, content provider 104 communicates a promotional preview 400 (e.g., in an embodiment of promotional preview 200 or promotional preview 300) to client device 112 via communication network 108 for display on display device 110.

At block 510, promotional media that corresponds to the on-demand content is communicated to the client device for display with the promotional preview. For example, content provider 104 also communicates promotional media 136 to the client device 112 via communication network 108 such that a display of the promotional media 404 that corresponds to on-demand content substantially coincides with a display of a preview segment in the promotional preview 400 that corresponds to the on-demand content.

At block 512, a content navigation input is received from the client device to advance or reverse the promotional preview. For example, content provider 104 receives a content navigation input from client device 112 via the communication network 108. The input from client device 112 can be generated from, or in response to, a user-selectable input 126 from a viewer that operates remote control device 124 to advance or reverse the promotional preview 400 (e.g., play, fast-forward, skip-ahead, skip-back, and rewind commands).

At block 514, a promotional media selection is received from the client device to obtain the on-demand content which is represented in the promotional preview by the corresponding preview segment. For example, content provider 104 receives a user selection of promotional media 404 from client device 112 via the communication network 108. The user selection can be generated from, or in response to, a user-selectable input 126 from a viewer that operates remote control device 124 to obtain the on-demand content which is represented in the promotional preview 400 by the corresponding preview segment. At block 516, the on-demand content that corresponds to the promotional media selection is communicated to the client device. For example, content provider 104 communicates the selected on-demand content 132 to the client device 112 via communication network 108 for display on display device 110.

FIG. 6 illustrates an exemplary method 600 for automatic content presentation, and is described with reference to client device 112 in the subscription content on-demand system 100 shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 602, a channel input to view on-demand content available via a subscription on-demand channel is received. For example, client device 112 receives a user-selectable input 126 from the user-operated remote control device 124 to select a subscription video on-demand channel 118 for viewing. At block 604, a promotional preview is rendered that includes preview segments of the on-demand content. For example, promotional preview 400 (e.g., in an embodiment of promotional preview 200 or promotional preview 300) is rendered for viewing on display device 110.

At block 606, promotional media that corresponds to the on-demand content is rendered for viewing where a display of a promotional media substantially coincides with a display of a preview segment in the promotional preview that corresponds to the on-demand content. For example, promotional media 404 that corresponds to on-demand content is rendered for viewing on display device 110. A display of the promotional media 404 substantially coincides with a display of a preview segment in the promotional preview 400 that corresponds to the on-demand content.

At block 608, a content navigation input to advance or reverse the promotional preview is received. For example, client device 112 receives a user-selectable input 126 from the user-operated remote control device 124 to advance or reverse the promotional preview 400 (e.g., play, fast-forward, skip-ahead, skip-back, and rewind commands). At block 610, a promotional media selection is received to initiate playback of the on-demand content which is represented in the promotional preview by the corresponding preview segment. For example, client device 112 receives a user-selectable input 126 from the user-operated remote control device 124 to select promotional media 404 which initiates playback of the on-demand content which is represented in the promotional preview 400 by the corresponding to preview segment.

It should be noted that any number of the method blocks described with reference to the methods 500 and 600 shown in respective FIGS. 5 and 6 can be combined in any order to implement alternative embodiments of automatic content presentation.

FIG. 7 illustrates various components of an exemplary digital video recorder (DVR)-enabled client device 700 in which embodiments of automatic content presentation can be implemented. The client device 700 can be implemented as any one or more of the electronic, computing, and client devices described herein. For example, client device 700 can be implemented with any number of the various components as client device 112 in the television-based client system 106 of the subscription content on-demand system 100 shown in FIG. 1.

Client device 700 includes one or more media content inputs 702 which may include Internet Protocol (IP) inputs over which streams of media content are received via an IP-based network (such as communication network 108 shown in FIG. 1). Device 700 further includes communication interface(s) 704 which can be implemented as any one or more of a serial and/or parallel interface, a wireless interface, any type of network interface, a modem, and as any other type of communication interface. A wireless interface enables device 700 to receive control input commands 706 and other information from an input device, such as from remote control device 708, PDA (personal digital assistant) 710, a cellular phone, or from another infrared (IR), 802.11, Bluetooth, or similar RF input device.

A network interface provides a connection between the client device 700 and a communication network by which other electronic and computing devices can communicate data with device 700. Similarly, a serial and/or parallel interface provides for data communication directly between device 700 and the other electronic or computing devices. A modem facilitates device 700 communication with other electronic and computing devices via a conventional telephone line, a DSL connection, cable, and/or other type of connection.

Client device 700 also includes one or more processors 712 (e.g., any of microprocessors, controllers, and the like) which process various computer executable instructions to control the operation of device 700, to communicate with other electronic and computing devices, and to implement embodiments of automatic content presentation. Device 700 can be implemented with computer readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 714 provides data storage mechanisms to store various information and/or data such as software applications and any other types of information and data related to operational aspects of the client device 700. For example, an operating system 716 and/or other application programs 718 can be maintained as software applications with the computer readable media 714 and executed on processor(s) 712 to implement embodiments of automatic content presentation. Further, the computer readable media 714 includes a program guide application 720 that is implemented to process program guide data 722 and generate program guides for display which enable a viewer to navigate through an onscreen display and locate broadcast programs, recorded programs, video on-demand programs and movies, interactive game selections, and other media access information or content of interest to the viewer.

The client device 700 can also include a DVR system 724 with playback application 726, and recording media 728 to maintain recorded media content 730. The DVR system 724, along with the playback application 726, can implement the various features and aspects of automatic content presentation, such as described in method 600 described with reference to FIG. 6.

The client device 700 also includes an audio and/or video output 732 that provides audio and video to an audio rendering and/or display system 734, or to other devices that process, display, and/or otherwise render audio, video, and display data. Video signals and audio signals can be communicated from device 700 to a television 736 via an RF (radio frequency) link, S-video link, composite video link, component video link, analog audio connection, or other similar communication link.

FIG. 8 illustrates an exemplary entertainment and information system 800 in which an IP-based television environment can be implemented, and in which embodiments of automatic content presentation can be implemented. System 800 facilitates the distribution of program content, program guide data, and advertising content to multiple viewers. System 800 includes a content provider 802 and television-based client systems 804(1-N) each configured for communication via an IP-based network 806.

The network 806 can be implemented as a wide area network (e.g., the Internet), an intranet, a Digital Subscriber Line (DSL) network infrastructure, or as a point-to-point coupling infrastructure. Additionally, network 806 can be implemented using any type of network topology and any network communication protocol, and can be represented or otherwise implemented as a combination of two or more networks. A digital network can include various hardwired and/or wireless links 808(1-N), routers, gateways, and so on to facilitate communication between content provider 802 and the client systems 804(1-N). The television-based client systems 804(1-N) receive program content, program guide data, advertising content, closed captions data, and the like from content server(s) of the content provider 802 via the IP-based network 806.

System 800 includes a media server 810 that receives program content from a content source 812, program guide data from a program guide source 814, and advertising content from an advertisement source 816. In an embodiment, the media server 810 represents an acquisition server that receives the audio and video program content from content source 812, an EPG server that receives the program guide data from program guide source 814, and/or an advertising management server that receives the advertising content from the advertisement source 816.

The content source 812, the program guide source 814, and the advertisement source 816 control distribution of the program content, the program guide data, and the advertising content to the media server 810 and/or to other television-based servers. The program content, program guide data, and advertising content is distributed via various transmission media 818, such as satellite transmission, radio frequency transmission, cable transmission, and/or via any number of other transmission media. In this example, media server 810 is shown as an independent component of system 800 that communicates the program content, program guide data, and advertising content to content provider 802. In an alternate implementation, media server 810 can be implemented as a component of content provider 802.

Content provider 802 is representative of a headend service in a television-based content distribution system, for example, that provides the program content, program guide data, and advertising content to multiple subscribers (e.g., the television-based client systems 804(1-N)). The content provider 802 can be implemented as a satellite operator, a network television operator, a cable operator, and the like to control distribution of program and advertising content, such as movies, television programs, commercials, music, and other audio, video, and/or image content to the client systems 804(1-N).

Content provider 802 includes various components to facilitate media data processing and content distribution, such as a subscriber manager 820, a device monitor 822, and a content server 824. The subscriber manager 820 manages subscriber data, and the device monitor 822 monitors the client systems 804(1-N) (e.g., and the subscribers), and maintains monitored client state information.

Although the various managers, servers, and monitors of content provider 802 (to include the media server 810 in one embodiment) are illustrated and described as distributed, independent components of content provider 802, any one or more of the managers, servers, and monitors can be implemented together as a multi-functional component of content provider 802. Additionally, any one or more of the managers, servers, and monitors described with reference to system 800 can implement features and embodiments of automatic content presentation.

The television-based client systems 804(1-N) can be implemented to include a client device 826 and a display device 828 (e.g., a television). A client device 826 of a television-based client system 804 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 804(N) is implemented with a computing device 830 as well as a client device 826. Additionally, any of the client devices 826 of a client system 804 can implement features and embodiments of automatic content presentation as described herein.

Although embodiments of automatic content presentation have been described in language specific to structural features and/or methods, it is to be understood that the subject of the appended claims is not necessarily limited to the specific features or methods described. Rather, the specific features and methods are disclosed as exemplary implementations of automatic content presentation.

1. A subscription video on-demand system, comprising:
subscription video on-demand channels each providing videos on-demand which can be selected for viewing;
a promotional preview to display video trailers corresponding to the videos on-demand that are available via a subscription video on-demand channel; and
a browser bar to display poster images that correspond to the videos on-demand, a display of a poster image that corresponds to a particular video on-demand substantially coinciding with a display of a video trailer in the promotional preview that corresponds to the particular video on-demand.

2. A subscription video on-demand system as recited in 1, wherein the promotional preview includes content navigation markers to enable content navigation of the promotional preview.

3. A subscription video on-demand system as recited in 1, wherein the poster image that corresponds to the particular video on-demand is selectable via the browser bar to initiate playback of the particular video on-demand which is represented in the promotional preview by the corresponding video trailer.

4. A subscription video on-demand system as recited in 1, wherein the poster images are navigable via the browser bar to at least one of advance or reverse the promotional preview to a video trailer that corresponds to a selected one of the poster images.

5. A subscription video on-demand system as recited in 1, wherein the promotional preview is generated by concatenating references to the video trailers corresponding to the videos on-demand that are available via the subscription video on-demand channel.

6. A subscription video on-demand system as recited in 1, wherein the promotional preview is generated by concatenating references to the video trailers and additional media content that is associated with at least one of the subscription video on-demand channel or the videos on-demand that are available via the subscription video on-demand channel.

7. A subscription content on-demand system, comprising:
subscription on-demand channels each providing on-demand content which can be selected for viewing; and
a promotional preview to display preview segments of the on-demand content that is available via a subscription on-demand channel, the promotional preview configured to enable content navigation of the promotional preview.

8. A subscription content on-demand system as recited in claim 7, further comprising a user interface to display promotional media that corresponds to the on-demand content, a display of a promotional media that corresponds to on-demand content substantially coinciding with a display of a preview segment in the promotional preview that corresponds to the on-demand content.

9. A subscription content on-demand system as recited in claim 8, wherein the promotional media is selectable via the user interface to initiate playback of the on-demand content which is represented in the promotional preview by the corresponding preview segment.

10. A subscription content on-demand system as recited in claim 8, wherein the promotional media is navigable via the user interface to at least one of advance or reverse the promotional preview to a preview segment that corresponds to a selected one of the promotional media.

11. A subscription content on-demand system as recited in claim 7, wherein the promotional preview is generated by sequencing references to the preview segments corresponding to the on-demand content that is available via the subscription on-demand channel.

12. A subscription content on-demand system as recited in claim 7, wherein the promotional preview is generated by sequencing references to the preview segments and additional media content that is associated with at least one of the subscription on-demand channel or the on-demand content that is associated with the subscription on-demand channel.

13. A subscription content on-demand system as recited in claim 7, further comprising a content data store configured to maintain selectable on-demand content associated with one or more of the subscription on-demand channels, the on-demand content that is available via a subscription on-demand channel being a subset of the selectable on-demand content.

14. A subscription content on-demand system as recited in claim 7, further comprising:
a content data store configured to maintain promotional media and selectable on-demand content associated with one or more of the subscription on-demand channels, the on-demand content that is available via a subscription on-demand channel being a subset of the selectable on-demand content; and
a content on-demand database configured to maintain data structures that correlate each subscription on-demand channel with the associated on-demand content and promotional media.

15. A subscription content on-demand system as recited in claim 7, further comprising:
a content data store configured to maintain the preview segments of the on-demand content that is available via a subscription on-demand channel; and
a content on-demand database configured to correlate the preview segments of the on-demand content to generate the promotional preview for the subscription on-demand channel.

16. A method, comprising:
receiving a channel input to view on-demand content available via a subscription on-demand channel;
rendering a promotional preview that includes preview segments of the on-demand content, the promotional preview configured to enable content navigation of the promotional preview; and
rendering promotional media that corresponds to the on-demand content, a display of a promotional media that corresponds to on-demand content substantially coinciding with a display of a preview segment in the promotional preview that corresponds to the on-demand content.

17. A method as recited in claim 16, further comprising receiving a content navigation input to at least one of advance or reverse the promotional preview.

18. A method as recited in claim 16, further comprising receiving a promotional media selection to initiate playback of the on-demand content which is represented in the promotional preview by the corresponding preview segment.

19. A method as recited in claim 16, further comprising generating the promotional preview by concatenating references to the preview segments and additional media content that is associated with at least one of the subscription on-demand channel or the on-demand content that is available via the subscription on-demand channel.

20. A method as recited in claim 16, further comprising:
identifying the on-demand content to be provided via the subscription on-demand channel, the on-demand content being a subset of selectable on-demand content maintained in a content data store; and
generating the promotional preview by concatenating references to the preview segments corresponding to the identified on-demand content.
